(19) United States
(12) Patent Application Publication
(10) Pub. No.: US 2011/0004819 A1
(43) Pub. Date: Jan. 6, 2011

(54) SYSTEMS AND METHODS FOR USER-DRIVEN DOCUMENT ASSEMBLY

(76) Inventor: James Hazard, Woodside, CA (US)

Correspondence Address: ROPES & GRAY LLP;IPRM - Floor 43, PRUDENTIAL TOWER, 800 BOYLSTON STREET, BOSTON, MA, 02199-3600, US

(21) Appl. No.: 12/830,912

(22) Filed: Jul. 6, 2010

Related U.S. Application Data
(60) Provisional application No. 61/270,039, filed on Jul. 3, 2009.

(51) Int. Cl. G06F 3/14; G06F 17/00

(52) U.S. Cl. 715/221; 715/234

(57) ABSTRACT

Document assembly systems and techniques are provided in which a user input is received indicating a form page and a list of data pages in a user-selected priority order, and the data in the form page processed to generate a document using content included in the data pages according to the priority order.

### CROSS-REFERENCE TO RELATED APPLICATION

This application claims the benefit of U.S. Provisional Application Ser. No. 61/270,039, filed Jul. 3, 2009, the entire contents of which are incorporated herein by reference.

### BACKGROUND

The field of document processing and creation has developed software and technological processes in an effort to make it easier for people to draft and prepare legal, business and other documents. In some areas, such as legal contract drafting, form documents are used as templates to help a lawyer avoid drafting inconsistencies and otherwise increase drafting efficiency. When a document is created, there are many situations in which some parts of the document that are regarded by the author and readers as generally applicable to that kind of document, and other parts are regarded as specific to a particular use. This is true of many documents such as applications, proposals, court filings and contracts. In contracts, for example, generally applicable portions may include intellectual property provisions and dispute resolution provisions, while specific portions may include price, party names and options. The distinction between specific and general often occurs on multiple levels. For example, a contract usually has provisions addressing issues that are common to nearly all contracts (e.g., choice of law and dispute resolution), other provisions that are common to contracts dealing with the kind of operation (e.g., license agreements), and more narrow or situation-specific provisions (such as patent licenses, contracts governed by particular state law, and contracts made by a particular organization). In many situations, including most contract negotiation settings, the text is often handled inefficiently because the specific and general issues are mixed together with no distinction as to the layer of generality, or only a bipolar distinction between transaction-specific issues and general issues. Participants are often required to read or reread texts to confirm that particular clauses state conventional ideas in conventional ways. To read and draft a contract with care and understanding requires great knowledge and training.

The inventor has previously disclosed a system in which parties could incorporate conventional agreement text hosted on a website purely by incorporating such text by reference to the website (see U.S. Patent Application Publication No. 2004/0009764, filed Jul. 14, 2003, incorporated by reference in its entirety herein). However, pure incorporation by reference to a website can be difficult for lawyers to adopt in their own practice, does not provide a powerful incentive to contribute, and requires higher levels of standardization and a significant change in practice habits. Form agreements can help the author, but are typically handled manually and may not help the readers. Form agreements often involve redundancy of standard provisions from one form to another, because they are not tailored to a particular area of use. Existing document assembly systems can be useful for highly repetitive situations, but are prohibitively difficult for non-specialists to program and understand. As a result, contract experts and parties cannot easily understand what is included in the resulting document unless they read the result, and have difficulty contributing new solutions to a broader knowledge base. Standardized terms and agreements depend on intense collaboration or a dominant participant to achieve standardization.

### SUMMARY

Described herein are systems and methods for generating documents by allowing a user to specify a form page and a priority-ordered list of data pages. The form page provides an “outline” for the document by including field indicators that are replaced with content during document generation by matching the field indicators of the form page with fields in the data pages. When multiple fields in the data pages may be matched with a particular field indicator, the highest priority field (according to the priority-ordered list of data pages) is used to provide content for the document.

The document assembly systems and techniques described herein may be advantageously applied when an individual or organization wants to generate one or more documents, all at once or at different times, and portions of the documents are similar to or the same as each other, or are similar to or the same as a previously-generated document. Some aspects of the system may be thought of as providing redundancy reduction by “factoring out” the repeated portions of a collection of documents. A user of this system can confirm that portions of the document conform to a precedent already existing in the system that the user is already aware of, or trusts because of the opinions or use by others, which reduces the need for reading and re-reading.

These systems and techniques also allow the separation of the transaction-specific portions (e.g., deal terms) from portions that are re-used from one document to the next (e.g., boilerplate clauses). Further, customizable collections of re-used portions can be assembled corresponding to different “use cases” (e.g., license of software only, or software and content), or by contributing author (e.g., intellectual property representations and warranties written or validated by an individual or organization). Using the systems and techniques disclosed herein, users can organize, customize and generate documents with great flexibility, according to their needs.

Systems and techniques for network-based document assembly are also disclosed herein, in which a multiplicity of users at remote locations can collectively edit a document, agree on the content and organization of the document, and generate the document. Systems and techniques are also provided for maintaining an inventory of documents and analyzing the inventory for patterns and statistics of use. A user accesses this inventory, along with the patterns and statistics, to guide his or her own document assembly process, thus benefiting from the knowledge, diligence and experience of others. The systems and techniques disclosed herein are particularly applicable to contract texts. An inventory of attested text, which comes from a known source, could enable longer, more structured documents without overloading the reader. Additionally, in legal document contexts, some interpretation attacks that can be made on text agreed in the intimacy of a two party negotiation are less likely to succeed when the terms are understood to be standards. The “intent” of a community can more easily “found” to be sensible than can the intent of two persons. The systems and techniques are also applicable to other document drafting situations, such as wills, court filings, probate papers, or non-legal documents such as advertising, news, media articles, reports and papers.

In some aspects, a method of assembling a document is provided. A plurality of data pages is presented to a user with a presentation device, each data page having at least one field. A field includes a field name and an associated item, and the associated item includes at least one of content and an indicator of another field. An input is received from the user, via an input device, with the input including an indication of a form page (selected by the user) having data including at least one field indicator. The input also includes an indication of a list of at least some of the plurality of data pages arranged by the user in an order indicative of the user's assembly priority of such data pages. The form page data is processed according to steps (a) and (b). Step (a) is processing content, and includes outputting the content to the document. Step (b) is processing a field indicator, and includes identifying the highest priority data page in the ordered list that includes a field matching the field indicator and identifying the item associated with the field. When the associated item is content, the content is processed according to step (a). When the associated item includes a field indicator, the field indicator is processed according to step (b).

In certain embodiments of this method, the associated item includes a field indicator by including a portion of a field indicator, and processing the field indicator according to step (b) includes processing the field indicator, of which the associated item includes a portion, according to step (b). In certain embodiments, when the associated item includes a field indicator, the form page data is modified by inserting the associated item into the form page data. In certain embodiments, all of the form page data is output to the document, and processing the form page data includes processing the form page data in the document. In certain embodiments, when no form indicators remain to be processed in the form page data, the method includes signaling completion of document assembly with the presentation device.

At least one of the data pages in the ordered list may be a case page that customizes the document for a user-selected application. At least one of the data pages in the ordered list may be a cover page that provides content for the document that is particular to a specific document.

In certain embodiments, a field indicator is a string of text demarcated by predetermined escape characters. At least one field indicator may include multiple text strings separated by predetermined delimiter characters, each text string matching at least one of: a field name included in at least one of the plurality of data pages, and a name of a data page of the plurality of data pages.

In certain embodiments, the input also includes an indication of at least one edit to at least one data page in the ordered list. In such embodiments, the method may also include updating the at least one data page with the at least one edit prior to processing the form page data. The method may also include presenting the at least one data page to the user as a text file in a text editor, wherein the indication of at least one edit includes a change made by the user to the text file in the text editor. The text file may be an HTML file. Updating the at least one data page may include creating a new version of the at least one data page and replacing the at least one data page in the ordered list of data pages with the new version. The indication of at least one edit may be associated with metadata indicating at least one of an identity of the user, a time of the at least one edit, the ordered list in connection with which the at least one edit was made, and a reason for the at least one edit. In certain embodiments, the method also includes determining that a data page in the ordered list is associated with a more current version, and at least one of: replacing the data page in the ordered list with the more current version prior to processing the form page data, notifying the user, requesting permission of the user before replacing the data page in the ordered list with the more current version, and notifying one or more past users of the data page.

In certain embodiments, an indication of document assembly requirements is received prior to processing the form page data. The document assembly requirements may include at least one of: one or more data pages that must be included in the ordered list, and guidelines for the user on data that is allowed to be included in at least one of the plurality of data pages.

When no data page in the ordered list includes a field name that matches the field indicator, a determination may be made as to whether a data page of the plurality of data pages has a page name matching the field indicator. In certain embodiments, when a data page of the plurality of data pages has a page name matching the field indicator, the field name comprises the page name and the item associated with the field name comprises the data in the data page. In certain embodiments, when no data page in the ordered list includes a field matching the field indicator, a marker is output to the document. When no data page in the ordered list includes a field that matches the field indicator, a new data page may be included in the ordered list, wherein the new data page includes a field that matches the field indicator. When no data page in the ordered list includes a field name that matches the field indicator, a new field may be included in a data page in the ordered list, wherein the new field matches the field indicator.

An input recommendation may be presented to a user based at least in part on at least one of the ordered list of data pages and the form page. The plurality of data pages may be presented to the user as a wiki application executed by a server, and the processing of the data in the form page may be performed by the server. In certain embodiments, the method further includes presenting to the user the document and information regarding at least some of the data pages in the ordered list.

In some aspects, a processing device is provided. The processing device is configured to communicate with a user input device and a presentation device, and is further configured to present a plurality of data pages to a user via the presentation device, each data page having at least one field, and receive an input from the user, via the input device. The input includes an indication of a form page, selected by the user, having data including at least one field indicator, and a list of at least some of the plurality of data pages arranged by the user in an order indicative of the user's assembly priority of such data pages. The processing device is further configured to process the form page data according to steps (a) and (b), as described above. In certain embodiments, the processing device is included in a web server. In certain embodiments, the processing device is included in a local server. The user input device may be a handheld user device, and may use a wireless communication protocol to communicate with the processing device.

### BRIEF DESCRIPTION OF THE DRAWINGS

The foregoing and other objects and advantages will be appreciated more fully from the following further description thereof, with reference to the accompanying drawings wherein:

FIG. 1A is a flow diagram of a method of assembling a document;

FIG. 1B depicts an illustrative document assembly system;

FIG. 2 illustrates a binder and data pages that can be utilized by the document assembly system of FIG. 1B;

FIG. 3 illustrates the processing of a document in accordance with the document assembly method of FIG. 1A;

FIGS. 4-7 depict illustrative user interface displays that can be used with the method of FIG. 1A;

FIG. 8 depicts a flow diagram of a versioning method;

FIG. 9 is a Venn diagram of relationships between different collections of data files;

FIGS. 10-11 depict additional illustrative user interface displays that can be used with the method of FIG. 1A; and

FIG. 12 depicts a network-based system 1200 configured to serve as the document assembly system of FIG. 1B.

### DETAILED DESCRIPTION

Described herein are systems and methods for generating documents by allowing a user to specify an electronic document “binder,” which can be edited and used to generate a document. In some aspects, the binder is a presentation arrangement that represents the data pages used in the assembly of a document, and serves as a conceptual aid for the user, who can conceptualize the process of document assembly as selecting and customizing data pages in a particular binder. In particular, the binder includes a form page and a priority-ordered list of data pages. The form page provides an “outline” for the document by including field indicators that are replaced with content during document generation by matching the field indicators of the form page with fields in the data pages. When multiple fields in the data pages may be matched with a particular field indicator, the highest priority field (according to the priority-ordered list of data pages) is used to provide content for the document. First, the processing of the data in the form page using fields and field indicators is described. Next, an example is provided to illustrate how the field/field indicator technology can be used to form a document binder and generate a document.

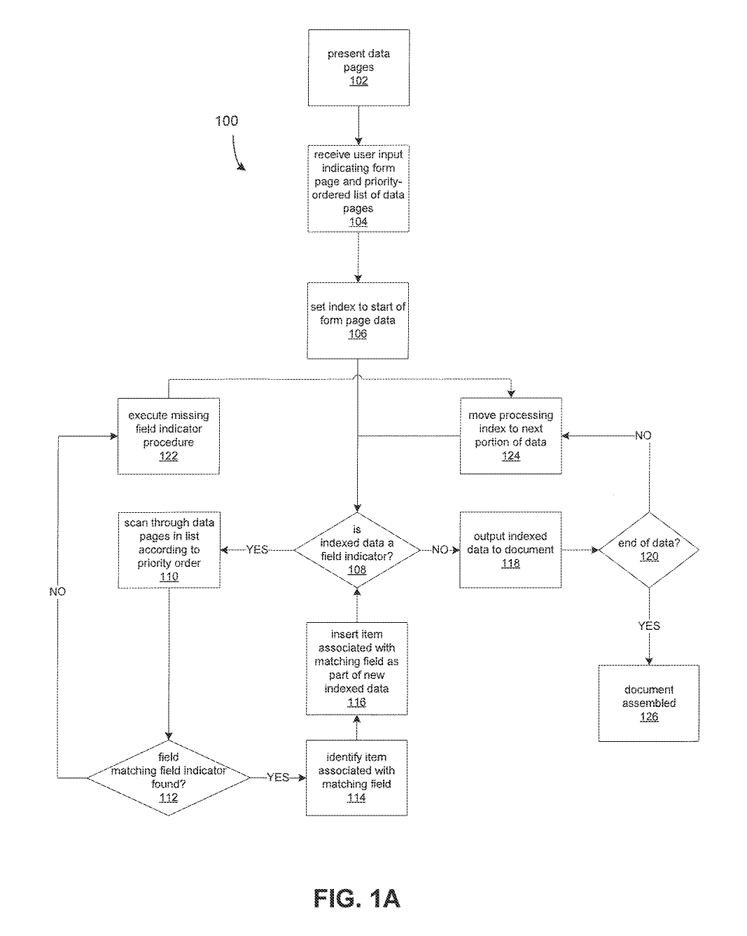

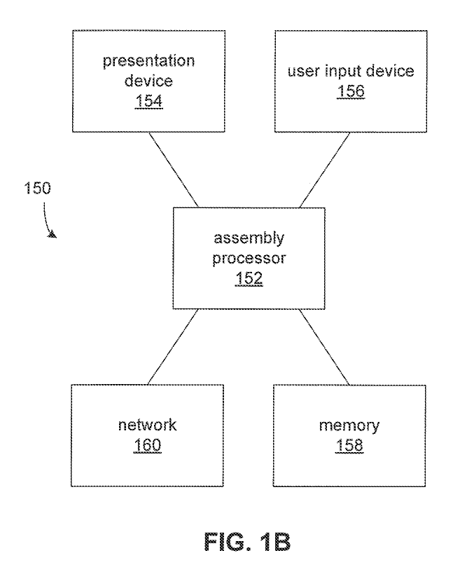

FIG. 1A is a flow diagram 100 of a method of assembling form and data pages into a desired document. FIG. 1B is a depiction of an illustrative document assembly system 150 configured to perform the method of FIG. 1A. The document assembly system 150 includes an assembly processor 152 communicably coupled to a presentation device 154, a user input device 156, a memory 158, and optionally a network 160. The presentation device 154 may include one or more of a visual display (e.g., a computer monitor, a television screen, a touch pad display, a handheld device display), a tactile display (e.g., a Braille display), an electronic speaker or other audio output, or any other device capable of presenting information to a user. The user input device 156 may include one or more of a mouse, trackball, remote control, touch screen, voice recognition system, or any other input device. The memory 158 may include one or more of a solid-state memory, a hard drive, network-based storage, smart cards or EEPROMs, memory media such as compact discs, DVDs and optical storage devices, or any other electronic memory. The communicable coupling between the elements of the document assembly system 150 may include one or more types of communication, including wired communication, wireless communication, Ethernet, telephone, satellite, and optical communication, as well as any other known communication type. The assembly processor 152 may include any processing device (such as one or more analog or digital microprocessors, personal computers or handheld computing devices, or network servers) configured to carry out the document assembly techniques described herein, including the method illustrated by the flow diagram 100 of FIG. 1A.

At the step 102 of the flow diagram 100, a plurality of data pages is presented to a user via the presentation device 154. Each data page is stored as an electronic data structure, which may be included in an electronic database, a web page, an electronic file, or a portion of an electronic file. These data structures may be stored locally to the user, or remotely, and may be accessed via a wired or wireless communications network such as the network 160 (e.g., the Internet). A data page includes electronically-represented data such as text, images, video, audio, hyperlinks, animations, address cards, applications, mixed media, and can include a combination of multiple types of electronically-represented data. For ease of illustration, the data pages described herein include text data, but any electronically-represented data (such as images and video) may be used with the document assembly systems and techniques disclosed herein. The plurality of data pages is presented to a user via the presentation device 154. Presenting a data page may include directly presenting the data included in the data page (e.g., the source code for a computer application), presenting a formatted version of the data included in the data page (e.g., a rendered version of RTF or HTML data, or other data written in a mark-up language such as wiki mark-up), presenting a title of the data page, presenting a description of the data page, presenting an icon or image representing the data page, presenting a directory or category of data pages, or any other way of indicating the data page to a user. In certain embodiments, the step 102 is performed by presenting a list or directory of data pages available to a user via a computer display. Presenting a data page may also include identifying a data page that has been created by a user (e.g., using a word processing or text entry application).

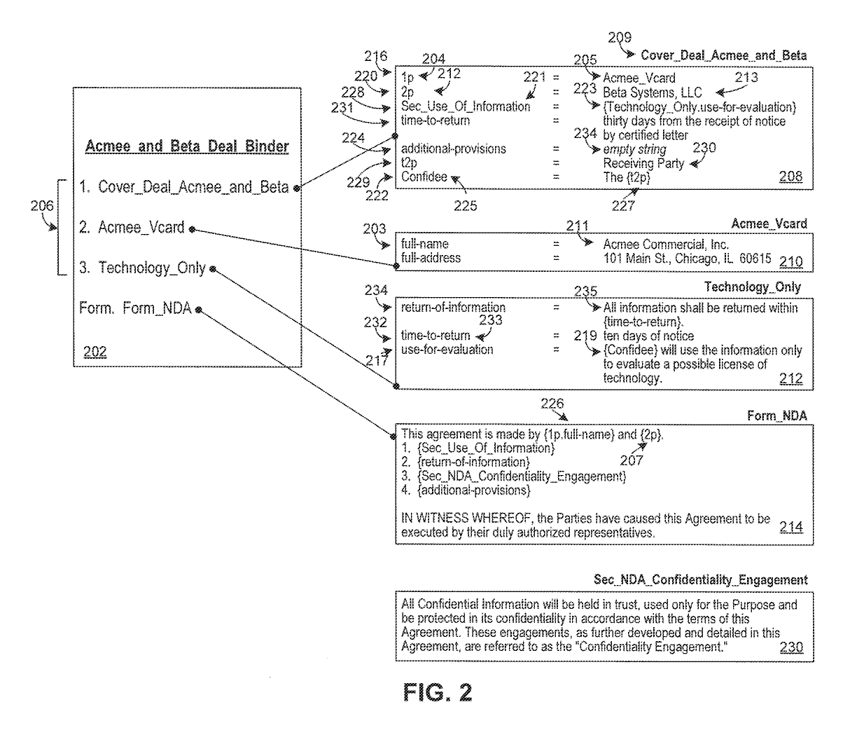

Each data page in the plurality of data pages presented at the step 102 includes at least one field. As used in this disclosure, a field is a data structure that includes at least a field name and an associated item. FIG. 2 illustrates several different data structures that can be utilized by the document assembly system 150, including several data pages such as the data page 208, which has a name 209 (“Cover_Deal_Acmee_and_Beta”) and seven fields. The field 216 has a field name 204 (“1p”), designating the first party in a contract, and an associated item 205 (“Acmee_Vcard”), which indicates a “business card” data page that includes the name and address of the first party.

As illustrated by the field 220 of the data page 208, which has a field name 212 (“2p”) and an associated item 213 (“Beta Systems, LLC”), the associated item can include content (such as data or representations of data to be included in the assembled document). The associated item in a field can also include a field indicator, which is an indicator, such as a pointer, reference or portion of a pointer or reference, to another field in the same data page or in a different data page to which a user can look to obtain content (or another field indicator of yet another field). The assembly processor 152 distinguishes a field indicator from content by particular formatting, text mark-up of the form or page data, the context in which the field indicator is used during document assembly, or inclusion in a particular data structure. In certain implementations, a field indicator is a string of text (which may include spaces) demarcated by predetermined escape characters. For example, the field 228 of the data page 208 has a field name 221 (“Sec_Use_Of_Information”) and an associated item 223 (“{Technology_Only.use-for-evaluation}”) that is a field indicator demarcated by curly braces that serve as the escape characters. The escape characters allow a user to readily distinguish content from field indicators, and are used by the assembly processor 152 during document generation as described below.

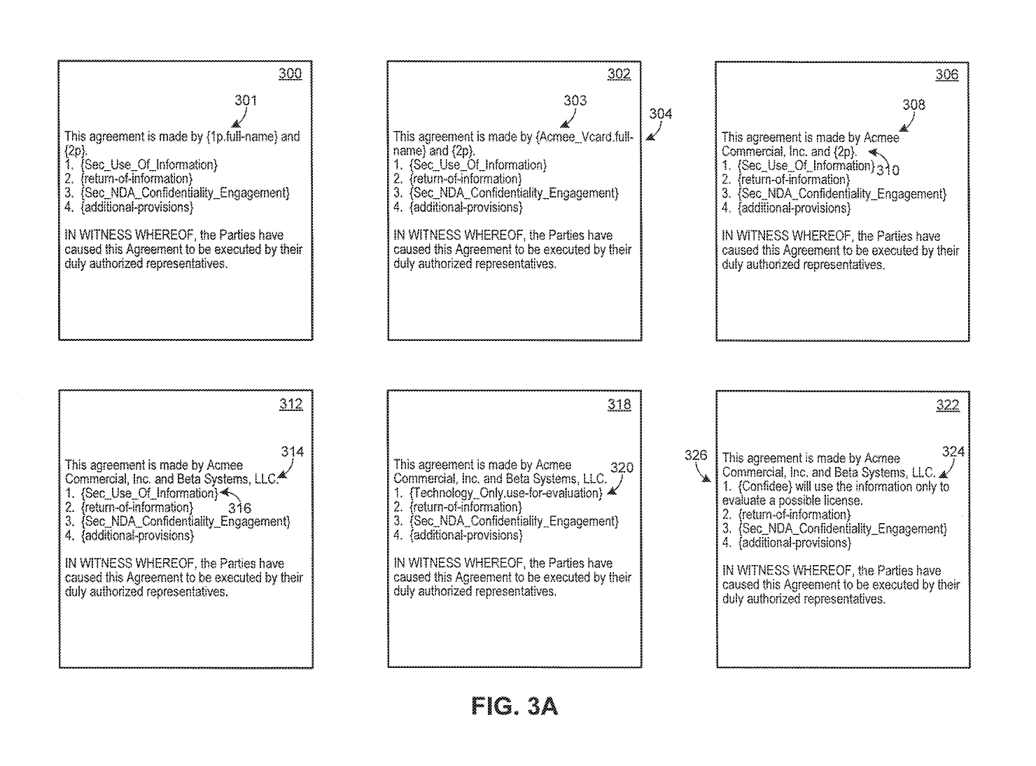

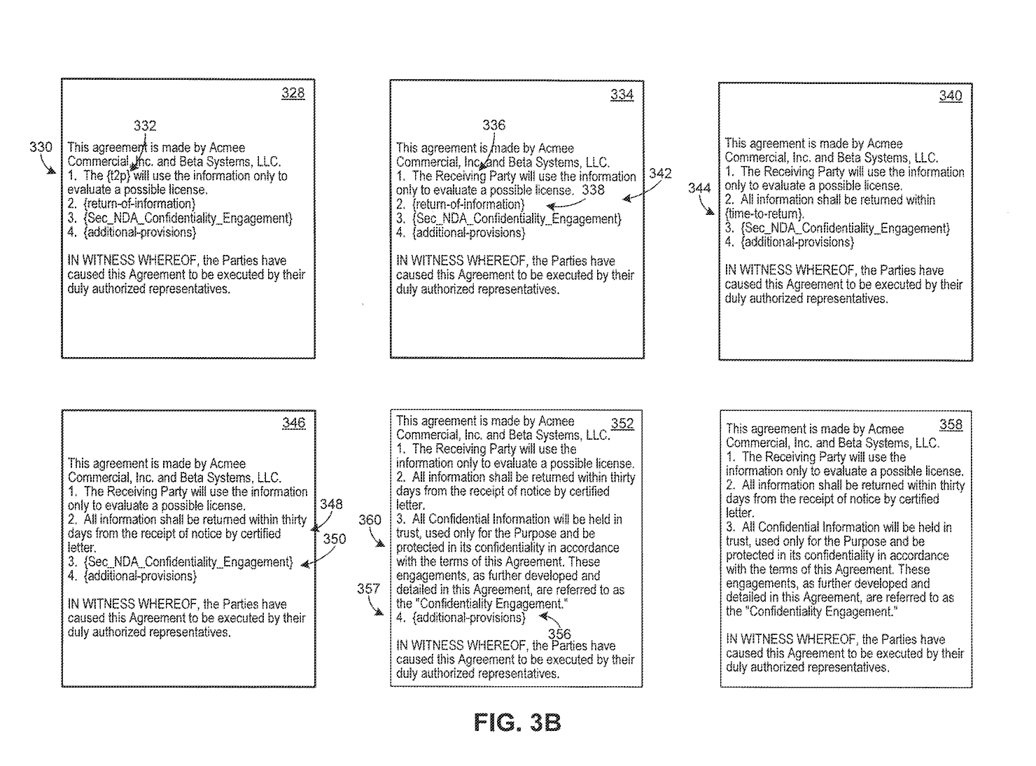

Additional delimiter characters can be used within a field indicator to provide additional information regarding the field indicated by the field indicator. For example, the field indicator 223 includes a period character “.” that separates the text string “Technology_Only” and the text string “use-for-evaluation”. The assembly processor 152 interprets the field indicator 223 as indicating a field with a field name that matches “use-for-evaluation” within a data page with a name that matches “Technology_Only”. Any data structure may be used for the fields and field indicators described herein, provided the assembly processor 152 is configured to recognize and process the data structures as desired. For example, the assembly processor 152 may be configured to interpret a field indicator of the form “{x.y}” as indicating a data page named “x” and a field named “y”. In certain implementations, one or more of “x” and “y” may themselves be field indicators or portions of field indicators, and may be processed as a field indicator by the assembly processor 152. For example, the assembly processor 152 may be configured to process the “x” of “{x.y}” as a field indicator on its own, but not process the “y” of “{x.y}” as a field indicator on its own (an example is described in the document assembly example illustrated by FIG. 3, with reference to the intermediate pages A 300, B 302 and C 306).

In another example, the assembly processor 152 is configured to separately process each of “x” and “y” as field indicators when “{x.y}” is encountered. If a field is found that matches “x”, the assembly processor 152 then determines whether a predetermined character (such as “*”) appears in the field name. If yes, the assembly processor 152 interprets “x” as the associated item of the matching field. If no, the assembly processor 152 does not interpret “x” as the associated item of the matching field. The delimiters and escape characters described and used in the examples herein are merely illustrative, and any suitable delimiters, escape characters, notation or data structures may be used in accordance with the disclosed systems and techniques.

In certain implementations, the associated item of a field may include a portion of a field indicator that is used in a complete field indicator during document generation. These portions may or may not be demarcated by escape characters, and thus may serve as either content or field indicators, depending upon the context in which they are used during document assembly. An example of this functionality is described in the document assembly example of FIG. 3, with reference to the intermediate pages A 300, B 302 and C 306. A field may include multiple content items and multiple field indicators, arranged in any order. For example, the field 222 of the data page 208 (“Cover_Deal_Acmee_and_Beta”) of FIG. 2 includes a field name 225 (“Confidee”) and an associated item 227 with both content (“The”) and a field indicator (“{t2p}”).

Returning to the flow chart 100 of FIG. 1A, once a plurality of data pages has been presented to the user at the step 102, the user selects a form page and a list of data pages to be used in assembling the document. To do this, the user provides an input at the step 104 via the input device 156. The input provided at the step 104 identifies a form page selected by the user, and a list of at least some of the plurality of data pages presented at the step 102.

A form page is a data page that is selected to provide a basis for the document to be assembled. The form page can be thought of as a “framework” or “outline” which is filled in by content when the document is assembled. The form page may be distinguished from other data pages in any of a number of different ways, including by having a particular data structure (different from the data structures of the other data pages), its name (e.g., including the text string “form”), its position in a list of data pages (e.g., at the top or bottom of the list, discussed in additional detail below), or any other designation by a user and/or the assembly processor 152. The data in the form page include one or more field indicators and can also include content, as discussed above. An example of a form page is the form page 214 (“Form_NDA”) in FIG. 2, which includes both content (e.g., the text strings “This agreement is made by ” and “IN WITNESS WHEREOF”) and field indicators (e.g., the field indicators “{1p.full-name}” and “{return-of-information}”).

As mentioned above, the input provided at the step 104 also includes an indication of a list of at least some of the plurality of data pages presented at the step 102. A list 206 of data page names is illustrated in FIG. 2. The system 150 presents the name of the form page 214 after this list, and arranges the list 206 and the form page name into a binder 202. As described above, in some aspects, the binder is a presentation arrangement that represents the data pages used in the assembly of a document. A binder may also correspond to a storage arrangement in the memory 158 (e.g., the data pages included in the binder may be associated with a binder entry in a database of documents generated by a document assembly system). A binder also serves as a conceptual aid for the user, who can conceptualize the process of document assembly as selecting and customizing data pages in a particular binder. In certain implementations, a binder is a data page itself, which references one or more other data pages and form pages to be used in the assembly of a document.

The user arranges the list indicated at the step 104 in an order indicative of the user's assembly priority of such data pages. The ordering of the list of data pages is used by the assembly processor 152 to match field indicators and include content in the document during document assembly. In particular, when a field indicator matches multiple field names of the data pages in the list, the assembly processor 152 preferentially uses the fields of “higher priority” data pages to replace the field indicators with content. Exemplary implementations of this processing approach are presented below and discussed with reference to FIG. 3.

After the user identifies a form page and creates a priority-ordered list of data pages at the step 104, processing of the form page data begins to ultimately create the desired document. The steps 106-124 of the flow diagram 100 illustrate a processing method, which will now be discussed in detail. At the step 106, the assembly processor 152 sets a processing index to indicate the beginning of the data included in the form page. The processing index is any type of counter or pointer variable used by the assembly processor 152 to keep track of the progress of document generation, for example, by indicating which parts of the page are currently being processed. Although FIG. 1A illustrates a particular processing sequence (i.e., processing the data in the form page substantially linearly from beginning to end), processing of the form page data may be programmed to occur in any order. In certain implementations, the assembly processor 152 processes the form page data by repeatedly returning to the beginning of the form page data, identifying the next unprocessed field indicator, and processing that field indicator before returning to the beginning of the form page data again. For any processing order, the assembly processor 152 may use the processing index to identify portions of data, such as field indicators or strings of content, and process these identified portions in accordance with the techniques disclosed herein. The data identified by the processing index (i.e., the portion of data indicated by the processing index and currently undergoing processing) is referred to herein as “indexed data”. During processing, the indexed data will change as the processing index is changed. In certain implementations, the indexed data is a portion of data demarcated by one or more escape or delimiter characters. An example of such an implementation is discussed below with reference to FIG. 3.

At the step 108, the assembly processor 152 determines whether the indexed data is a field indicator. This determination may be made by recognizing predetermined escape characters, predetermined delimiter characters, a particular data structure, a formatting type, or other field indicator designations as discussed above. If the indexed data is determined to be a field indicator, the assembly processor 152 scans through the data pages in the list of data pages indicated at the step 104, in the priority order specified by the user, to find a field that matches the field indicator or a portion of the field indicator. In certain implementations, when a field indicator does not include any delimiter characters (e.g., the field indicator 207 “{2p}” of the form page 214 of FIG. 2), finding a field to match the field indicator includes finding a field name with an identical name as the text between the escape characters of the field indicator. For example, the field name 212 (“2p”) of the data page 208 (“Cover Deal Acmee and Beta”) is identical to the text between the escape characters “{” and “}” of the field indicator 207 (“{2p}”). In certain implementations, when a field indicator does include one or more delimiter characters (e.g., the field indicator 226 “{1p.full-name}”), the assembly processor 152 interprets the information provided by the delimiter characters to find a field matching the field indicator. For example, in the case of the field indicator 226 (“{1p.full-name}”) as interpreted herein, a field that matches the field indicator 226 has a field name “full-name” and may be in a data page named “1p” or in a data page with a name that is not “1p”, but is identified with the field-name “1p” by another field included in the list of data pages 206 (discussed and illustrated in additional detail below). In certain embodiments, identical matches between the field indicators and the field names are not required. Instead, a field name and a field indicator that are substantially identical or substantially similar may be considered a match, or may be flagged and presented to the user as a possible match. The criteria for “substantially identical” and “substantially similar” may be based on statistical data of past data and form pages (e.g., identifying common misspellings or typographical errors, or the popularity of different field indicators which may suggest one or more that are most likely to be intended), case folding (upper and lower case), regular expressions (in the computing sense), alternate spellings of commonly-used terms (such as “meter” and “metre”), as well as user-defined shorthand stored in the memory 158 (such as using “disc” for “disclosure”).

As discussed above, the assembly processor 152 uses priority order of the data pages in the list indicated at the step 104 to determine the order through which to scan the fields in the data pages to locate a match to the field indicator at the step 110. If no match is found in the data pages in the list, the assembly processor 152 executes a missing field indicator procedure at the step 122, examples of which are discussed in detail below, then moves the processing index to the next portion of data at the step 124. When a first match is found between the field indicator and a field, the assembly processor 152 stops scanning the data pages and continues processing at the step 114. This occurs even if another field that matches the field indicator is included later in the same data page or in a data page with a lower priority than the page in which the first match was found. In this manner, the system 150 gives “precedence” to particular fields, i.e., the data in a higher position or a higher priority data page is preferentially used during document assembly over the data in a lower priority position or data page. Thus, at the conclusion of the step 112, the assembly processor 152 has identified the highest priority data page in the ordered list of data pages that includes a field matching the field indicator (if such a data page exists).

After identifying the highest priority data page in the step 112 as just described, at the step 114, the assembly processor 152 identifies the item associated with the matching field. For example, if the indexed data at the step 108 is the field indicator 226 (“{1p.full-name}”) of the form page 214 (“Form NDA”), the assembly processor 152 scans through the data pages in the priority order represented by list 206 (i.e., starting with the data page 208 “Cover_Deal_Acmee_and_Beta”) until the first matching field name is found. In the example of FIG. 2, the first matching field 216 has the field name 204 (“1p”) of the data page 208 (“Cover_Deal_Acmee_and_Beta”). The item associated with the field 216, the text 205 (“Acmee_Vcard”) is identified at the step 114.

Once the associated item has been identified at the step 114, the assembly processor 152 inserts this identified associated item into the form page. The inserted item replaces the field indicator or a portion of the field indicator, as described in additional detail below. At the step 116, the inserted item becomes at least part of the new indexed data. The assembly processor 152 then repeats the step 108 again, this time with reference to the new indexed data. This process is illustrated below with reference to FIG. 3.

As described above, if the assembly processor 152 determines at the step 108 that the indexed data is a field indicator, the assembly processor 152 proceeds to execute the step 110. However, if the assembly processor 152 determines that the indexed data is not a field indicator at the step 108 (e.g., the indexed data is some form of content), the indexed data is output to the document at the step 118. At the step 120, the assembly processor 152 determines whether all of the form data has been processed (e.g., by determining whether the processing index has reached the end of the form data). If additional form page data remains to be processed, the assembly processor 152 moves the processing index to make a new portion of data the indexed data at the step 124, and then executes the step 108 on the new indexed data. At the step 120, if the assembly processor 152 determines that all of the form data has been processed, then the document has been assembled and is generated for presentation to the user at the step 126.

An example document assembly performed in accordance with the document assembly method of FIG. 1A is now discussed with reference to the binder 202 of FIG. 2 and illustrated in FIG. 3. As mentioned above, the binder 202 includes a list 206 of data page names, as well as a form page name. The data pages named in the list 206 each include fields, which in turn include a field name and an associated item. In certain implementations, at least one of the data pages named in the list 106 is a “case page” which customizes the document for a user-selected application. For example, the data page 212 (“Technology_Only”) is a “case page” that is included in a binder when the user is assembling a non-disclosure agreement in which the confidee is limited to using the information only to evaluate a license of the confider's technology. In certain implementations, at least one of the data pages in the list 206 is a “deal page” which provides content for the document that is particular to a specific transaction. For example, the data page 208 (“Cover_Deal_Acmee_and_Beta”) is a deal page that provides information regarding the specific parties (Acmee Commercial, Inc. and Beta Systems, LLC) engaging in a business transaction or legal agreement.

FIG. 3 illustrates the processing of an example document corresponding to the binder 202 of FIG. 2 using the document assembly method of FIG. 1A. In the embodiment illustrated in FIG. 3, the document is generated by sequentially generating a number of intermediate documents, each including additional refinements over the last, with the processing concluding with a final assembled document. At the beginning of processing (the step 106 of FIG. 1A), the first intermediate document A 300 (FIG. 3A) includes exactly the data of the form page 214 (“Form_NDA”) of the binder 202 of FIG. 2. As the assembly processor 152 processes the data in the intermediate page A 300, the content in the data is preserved in the intermediate document A 300 (the steps 118 and 124 of FIG. 1A) until the first field indicator 301 (“{1p.full-name}”) is identified (the determination “YES” at the step 308 of FIG. 1A). The assembly processor 152 then executes the step 110 of FIG. 1A, scanning through the data pages in the list 206 according to the priority order until a matching field 216 (with the field name 204 “1p” in the data page 208 “Cover_Deal_Acmee_and_Beta”) is found (the determination “YES” at the step 312 of FIG. 1A). The item 205 (“Acmee_Vcard”) associated with the field 216 is identified (the step 114 of FIG. 1A), and the item 205 is inserted into the document as an insert 303 in the intermediate document B 302 (the step 116 of FIG. 1A).

Once the insert 303 has been included in the intermediate document B 302, the assembly processor 152 uses the processing index to identify the next field indicator 304 (“Acmee_Vcard.full-name”). In other words, the field indicator 301 (“{1p.full-name}”) of the form 214 (“Form_NDA”) is “replaced” during processing by the field indicator 304 (“{Acmee_Vcardfull-name}”) because of the field 216 (“1p=Acmee_Vcard”) in the data page 208 (“Cover_Deal_Acmee_and_Beta”). To process the field indicator 304, the assembly processor 152 scans through the data pages in the list 206 according to the priority order until a matching field 203 (the field name “full-name” in the data page 210 “Acmee_Vcard”) is found. The item 211 (“Acmee Commercial, Inc.”) associated with the field 203 is identified, and the item 211 is inserted into the document as an insert 308 in the intermediate document C 306.

The assembly processor 152 continues to move the processing index through the data of intermediate document C 306, preserving the content in the data until the next field indicator 310 (“{2p}”) is identified. The data pages of the list 206 are again scanned according to their priority order until a matching field 220 (with the field name 212 “2p” in the data page 208) is found. The item 213 (“Beta Systems, LLC”) associated with the field 220 is identified, and the item 213 is inserted into the document as an insert 314 in the intermediate document D 312.

The assembly processor 152 continues to move the processing index through the data of intermediate document D 312, preserving the content in the data until the next field indicator 316 (“{Sec_Use_Of_Information}”) is identified. The data pages of the list 206 are again scanned according to their priority order until a matching field 228 (with the field name 221 “Sec_Use_Of_Information”) is found. The item 223 (“{Technology_Only.use_for_evaluation}”) associated with the field 228 is identified, and the item 223 is inserted into the document as an insert 320 in the intermediate document E 318. The item 223 (and consequently the insert 320) includes a field indicator, so the assembly processor 152 then processes the insert 320 in accordance with the flow diagram 100 of FIG. 1A. The data pages of the list 206 are scanned according to their priority order until a matching field 217 (with the field name “use-for-evaluation” in page 212 “Technology_Only”) is found. The item 219 (“{Confidee} will use the information only to evaluate a possible license of technology}”) associated with the field 217 is identified, and the item 219 is inserted into the document as an insert 324 in the intermediate document F 322.

As occurred in the processing of the intermediate document E 318, the insert 324 in the intermediate document F 322 includes a field indicator 326, so the assembly processor 152 then processes the field indicator 326 included in the insert 324 in accordance with the flow diagram 100 of FIG. 1A. The data pages of the list 206 are scanned according to their priority order until a matching field 222 (with the field name 225 “Confidee”) is found. The item 227 (“The {t2p}”) associated with the field 222 is identified, and the item 227 is inserted into the document as an insert 330 in the intermediate document G 328.

Since the insert 330 in the intermediate document G 328 includes a field indicator 332 (“{t2p}”), the assembly processor 152 processes this field indicator 332. The data pages of the list 206 are scanned according to their priority order until a matching field 229 (with the field name “t2p”) is found. The item 230 (“Receiving Party”) associated with the field 229 is identified, and the item 230 is inserted into the document as an insert 336 in the intermediate document H 334 (FIG. 3B).

The assembly processor 152 continues to move the processing index through the data of the intermediate document H 334, preserving the content in the data until the next field indicator 338 (“{return-of-information}”) is identified. The data pages of the list 206 are scanned according to their priority order until a matching field 234 (with the field name “return-of-information” in the data page 212 “Technology_Only”) is found. The item 235 (“All information shall be returned within {time-to-return}”) associated with the field 234 is identified, and the item 235 is inserted into the document as an insert 342 in the intermediate document I 340.

Since the insert 342 in the intermediate document I 340 includes a field indicator 344 (“{time-to-return}”), the assembly processor 152 processes this field indicator 344. The data pages of the list 206 are scanned according to their priority order until a matching field 231 (with the field name “time-to-return” in the data page 208 “Cover_Deal_Acmee_and_Beta”) is found. Observe that another field 232 (of the data page 212 “Technology Only”) also includes a field name 233 matching the field indicator 344 (“{time-to-return}”). However, since the data page 208 has a higher priority than the data page 212, the field 231 is considered the correct match to the field indicator 344. The item 237 (“thirty days from the receipt of notice by certified letter”) associated with the field 231 is identified, and the item 237 is inserted into the document as an insert 348 in the intermediate document J 346.

The assembly processor 152 continues to move the processing index through the data of the intermediate document J 346, preserving the content in the data until the next field indicator 350 (“{Sec_NDA_Confidentiality_Engagement}”) is found. The data pages of the list 206 are scanned according to their priority order, but there is no field name in any of the data pages of the list 206 that matches the field indicator 350 (a determination of “NO” at the step 112 of FIG. 1A). As described above, the assembly processor 152 then executes a missing field indicator procedure at the step 122. In certain implementations, the missing field indicator procedure includes determining whether any data page, in the plurality of data pages from which the list of data pages (e.g., the list 206 of FIG. 2) was drawn, has a page name matching the field indicator. If such a data page can be found, then the assembly processor 152 will treat that data page as a matching field, with the name of that data page as the field name and the data in that data page as the item associated with the field for the purposes of the flow diagram 100 of FIG. 1A. Such an implementation is illustrated in FIG. 3. Because no field name in any of the data pages of the list 206 matches the field indicator 350

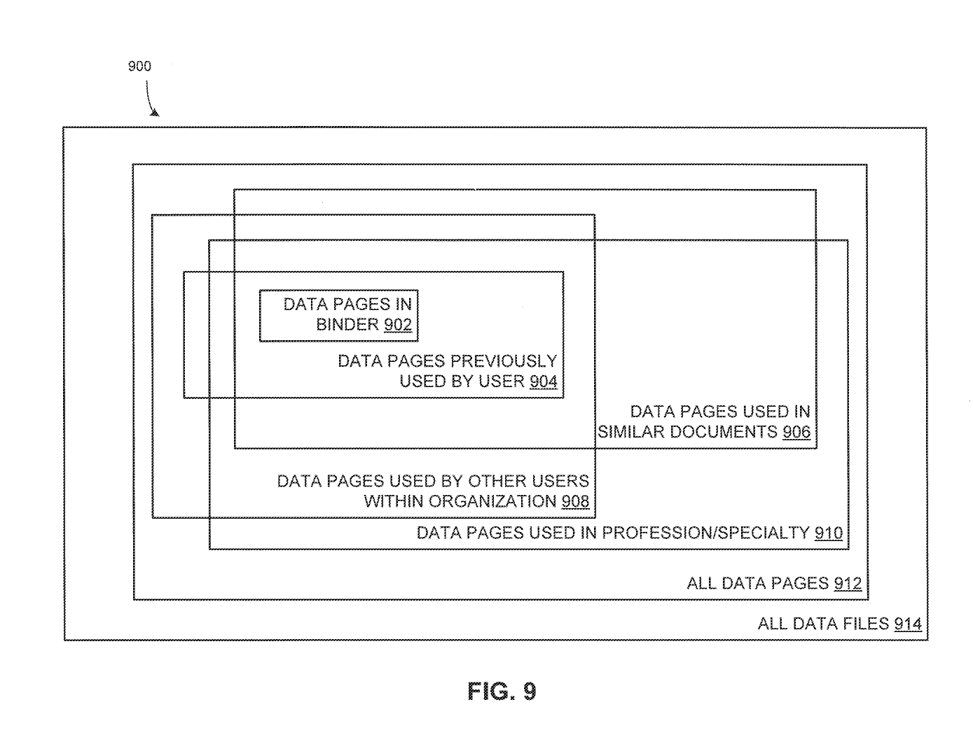

(“{Sec_NDA_Confidentiality_Agreement}”), the assembly processor 152 searches all of the data pages in its memory 158 and finds the data page 230 of FIG. 2. The data of the data page 230 is inserted into the document as an insert 360 in the intermediate document K 352. It will be noted that data page 230 does not contain any fields or indicators, only content, but it may contain any combination of fields, field indicators and content. Different ways in which the assembly processor 152 may search the data pages (and data files more generally) in the memory 150, are discussed below with reference to FIG. 9.

Other missing field indicator procedures may be implemented at the step 122, in addition to or instead of the procedure just described. For example, when no data page in the ordered list of data pages includes a field matching the field indicator, the assembly processor 152 may output a marker to the document, such as “MISSING INDICATOR” highlighted in a boldfaced, colored font. The marker can include information about the missing field indicator, and can alert a user to this condition so that the user can return to the binder and correct the error. In certain implementations, the missing field indicator procedure includes creating a new field in the highest priority data page with the missing field name and no associated item (e.g., an empty string), which the user may provide with the desired item. In certain implementations, the assembly processor 152 presents a suggested field indicator to the user, based on similar or similarly-used field indicators in other data pages and form pages in the binder being assembled, or other binders available to the system 150.

Returning to the intermediate document K 352 of FIG. 3, the assembly processor 152 continues to move the processing index through the data of the intermediate document K 352, preserving the content in the data until the next field indicator 356 (“{additional-provisions}”) is found. The data pages of the list 206 are scanned according to their priority order until a matching field 224 (“additional-provisions”) is found. However, the item 234 associated with the field 224 is an empty string. In certain embodiments, the assembly processor 152 treats an empty string item as intentionally omitted and deletes the document list item 357 (“4.”) from the intermediate document K 352 to create the next document 358.

The assembly processor 152 continues to move the processing index through the data of the document 358, preserving the content in the data until the next field indicator is found. However, there are no remaining field indicators in the document. Once the processing index has been moved through all of the content of the document 358, the end of the data is reached (a determination of “YES” at the step 120 of FIG. 1A) and the resulting document 358 may be generated and presented to the user (the step 124 of FIG. 1A). The generated document may be displayed, saved, e-mailed, printed, faxed, posted to a web site, or transmitted or presented to a user via the presentation device 154, the network 160, or any other mechanism.

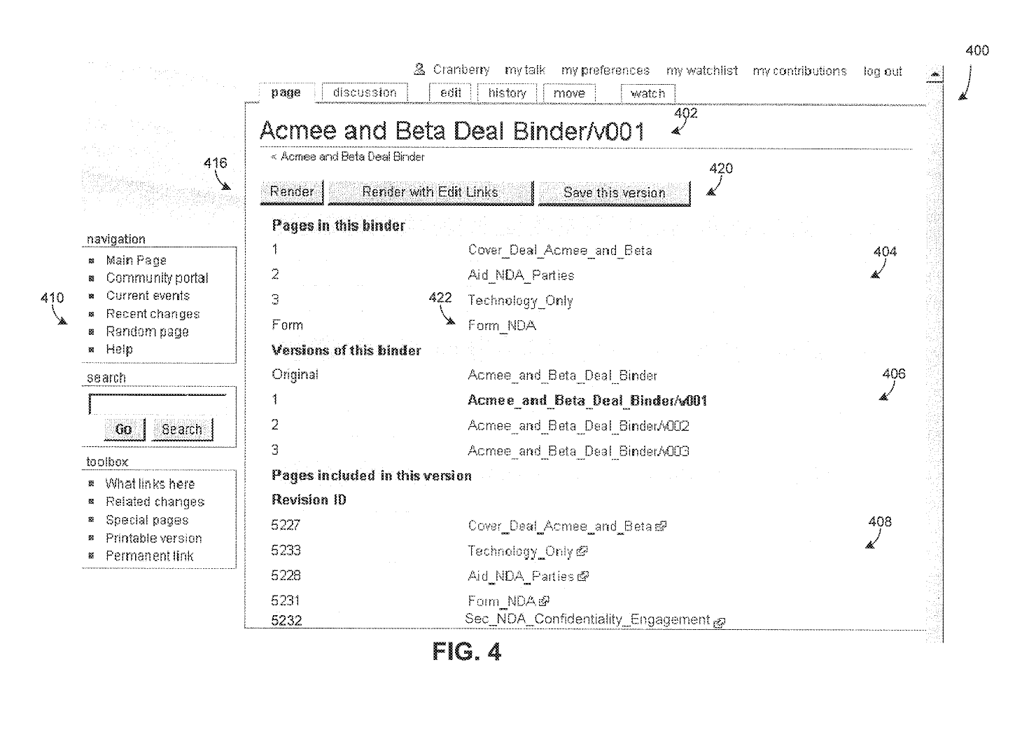

The document assembly method of FIG. 1A may be presented to a user by the assembly processor 152 via a user interface on the presentation device 154. FIG. 4 depicts an illustrative user interface display 400 that can be used with the method of FIG. 1A to present the generated document and information regarding at least some of the data pages in the binder. As illustrated, in certain implementations, the plurality of data pages presented to the user at the step 102 of FIG. 1A are presented to the user by a wiki application executed by a server, such as a web or intranet server. In some such implementations, the processing of the data in the form page (i.e., the steps 108-124 of FIG. 1A) is performed by the server. In particular, the display 400 represents the contents of a binder with a title 402 (“Acmee and Beta Deal Binder/v001”). The display 400 includes three sections: the section 404 (“Pages in this binder”), the section 406 (“Versions of this binder”), and the section 408 (“Pages included in this version”). A functions region 410 of the display 400 includes navigation functions, search functions and additional functions, as are known in the art. In some implementations, a category section (not shown) indicates categories into which the data pages listed in the binder (e.g., in the section 404) may belong, or other categories related to the binder (such as business or practice specialty categories). The render button 416 allows a user to initiate the generation of a document according to the method of the flow diagram 100 of FIG. 1A, which creates the document defined by the binder represented in the display 400. The section 404 includes an ordered list of data pages, as well as a form page title 422. A user may select any of the pages included in the binder to view the contents of that page (e.g., by using a cursor or touch pad to indicate a page).

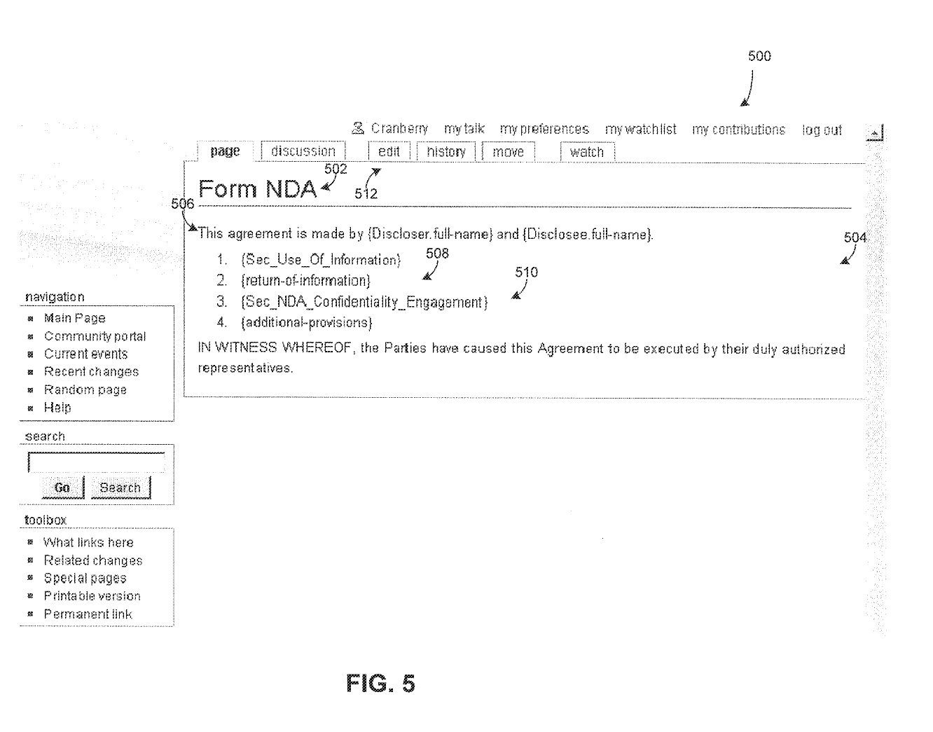

In certain implementations, in response to receiving a user selection of the form page title 422, the display 500 of FIG. 5 is presented to the user via the presentation device 154. The display 500 includes the form page title 502 and the form data 504 included in the form page. The data 504 includes text content, such as the text content 506, as well as field indicators such as the field indicator 508 and the field indicator 510.

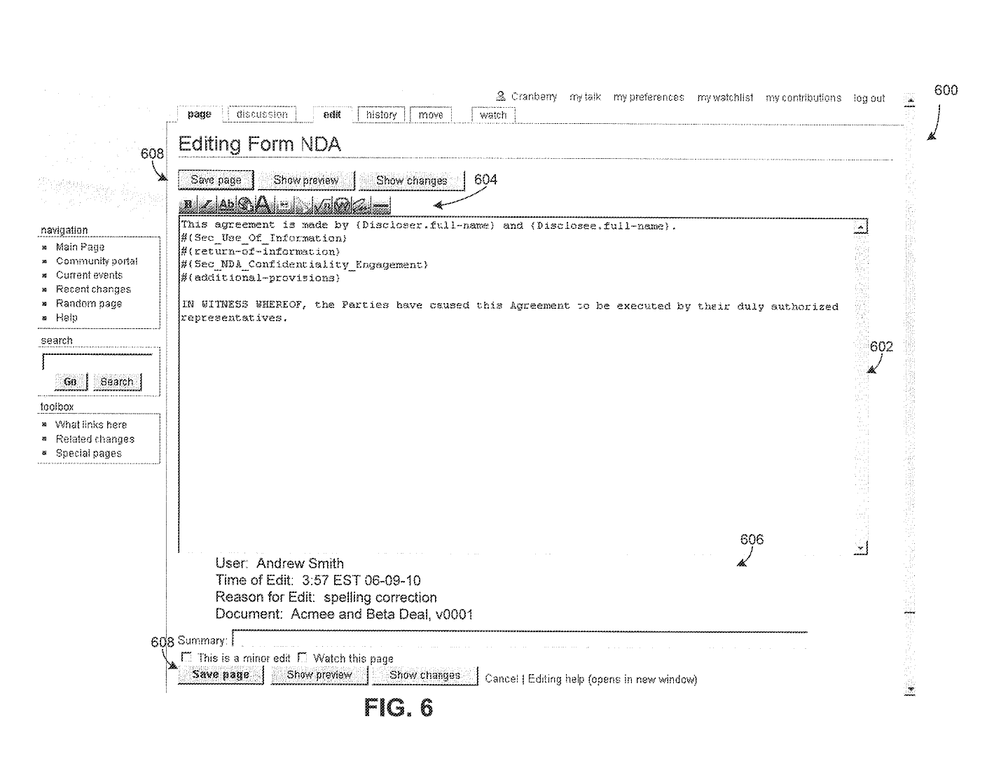

In response to the user selecting the edit tab 512 at the top of the display 500, the presentation device 154 presents the display 600 of FIG. 6. The display 600 includes a text field 602 in which the form page data may be edited by the user via the input device 156 (e.g., a keyboard or touch pad). Additional word processing function buttons 604 are also included in the display 600, allowing the user to perform known word processing functions on the text within the text field 602. In certain implementations, form pages and data pages are HTML or other mark-up language documents that can be actively edited by a user in a word processing application (e.g., a simple text editor for RTF or XML documents, or a more full-featured application such as Microsoft Word or OpenOffice) installed on a user's local device (e.g., desktop, laptop or handheld device), while the remainder of the document assembly process is performed by an assembly processor 152 located on a remote server. In certain implementations, the assembly processor 152 recognizes an input from the input device 156 including an indication of at least one edit to at least one data page in an ordered list (e.g., the ordered list of data pages in the section 404 of the display 400 of FIG. 4), and in response, the assembly processor 152 updates the at least one data page with the at least one edit, prior to processing the data in the form page. In some such implementations, at least one data page is presented to the user in a plain text or HTML format in a text editor. A change made by the user to the plain text or HTML in the text editor can be flagged or annotated to indicate an edit made to the data page. In certain implementations, when a user edits a field in a data page in the binder, the assembly processor 152 records the edit as a new, modified field with the same field name in the highest priority page, or some lower priority page selected by the user. In certain implementations, the assembly processor 152 receives a user input to change a priority of one or more fields, and in response, “pushes” the one or more fields “down” the priority list within the same data page or into another data page that the user regards as appropriate (e.g., by rearranging the data pages and/or fields in the memory 158). Similarly, the assembly processor 152 may push one or more fields “up” the priority list within the same data page or into a higher priority data page in response to a user input. Additionally, the assembly processor 152 may push one or more data pages “up” or “down” in the priority list in response to a user input.

The display 600 of FIG. 6 includes an annotation region 606. An annotation region may indicate metadata associated with a binder, a data page, a form page, or an edit thereof. For example, the annotation region 606 indicates the identity of the user, a time of the edit, the binder in connection with which the edit was made, and a reason for the edit. The metadata in an annotation region may be automatically included by the assembly processor 152 (e.g., the time of an edit), manually included by a user (e.g., a reason for the edit), or a combination of the two.

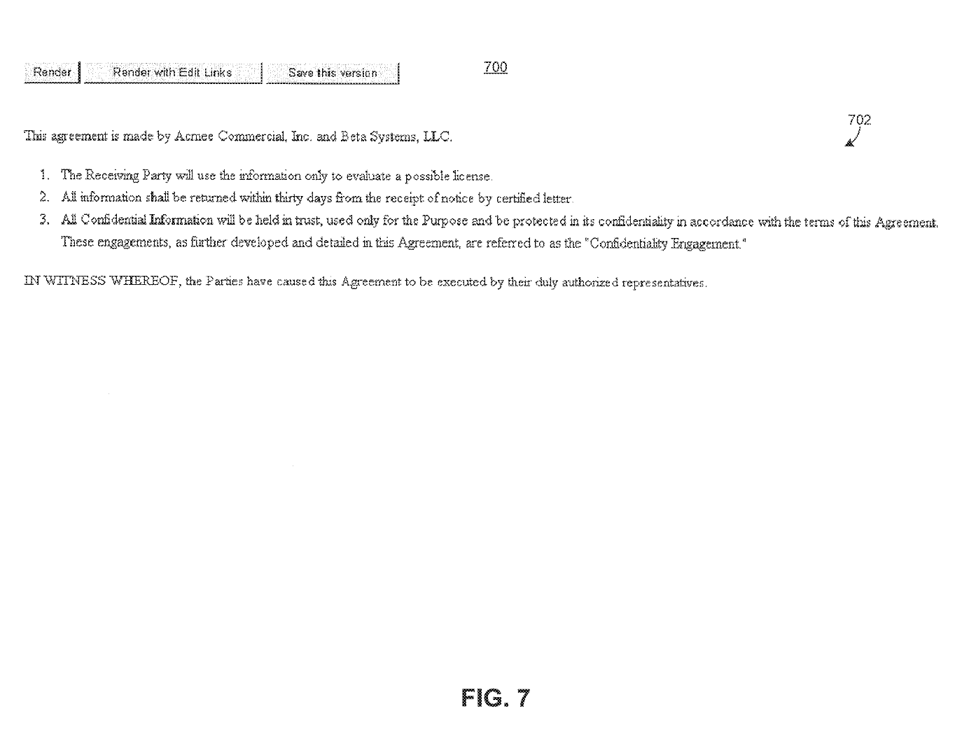

When the user selects the save page button 608, a display (similar to the display 500 of FIG. 5) is presented, reflecting the edits made by the user. When the user returns to the display 400 of FIG. 4, and selects the render button 416, the display 700 of FIG. 7 is presented. The display 700 includes the generated document 702 as assembled by the assembly processor 152 in accordance with the document assembly method illustrated in FIG. 1A. In certain implementations, a user is given the option to select between a number of different presentation formats of the generated document. Examples of different presentation formats include a final document, a draft document in which there is special formatting around the parts of the text that correspond to recent edits or that were included in different data pages in the binder (e.g., the data pages and fields <a href=“Acmee Vcard#full-name”> identified during the processing of the data in the form page), and a “linked” document that allows a user to select a portion of the generated document to navigate directly to the data page and field that supplied the selected portion (e.g., through href navigation in an HTML document), or to “mouse-over” or select a field, in response to which a text edit function is presented to the user for editing the selected field.

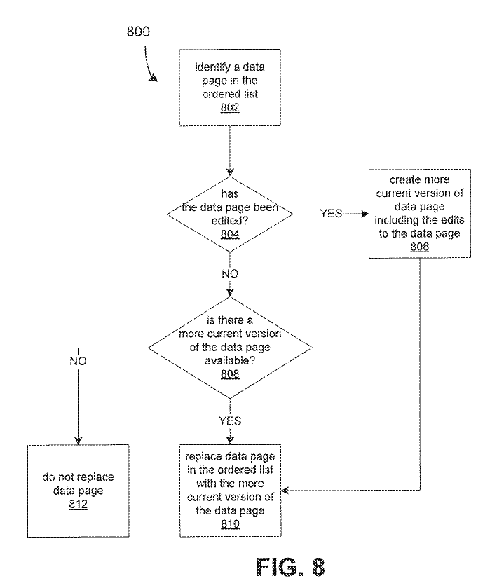

In certain implementations, the document assembly systems and techniques disclosed herein include versioning systems and techniques. Some such implementations prevent a data page from being edited when other binders include that data page, thus preventing breaks in the integrity of the documents generated from these other binders. Instead, new versions of a data page are created that include the edits. FIG. 8 depicts a flow diagram 800 of a versioning method used to maintain and update different versions of data pages. At the step 802, the assembly processor 152 identifies a data page in the ordered list of data pages (i.e., the list received from the user at the step 104 of the flow diagram 100 of FIG. 1A). This identification may arise from a user selection of a data page using the input device 156, or may be made by the assembly processor 152 as part of an automatic version check of the data pages prior to document assembly. At the step 804, the assembly processor 152 determines whether the identified data page has been edited or otherwise changed by the user or another entity. If the identified data page has been edited, the assembly processor 152 creates a more current version of the data page, with the more current version including the edits to the data page. The assembly processor 152 then replaces the identified data page in the ordered list of data pages (e.g., by changing a pointer in memory) so that when the user generates a document using the ordered list, the document will reflect the edits.

At the step 804, if the identified data page has not been edited, the assembly processor 152 determines whether a more current version of the data page is available at the step 808. This may occur, for example, when the legal department of a corporation uploads an updated set of boilerplate clause data pages to the document assembly system 150, with similar or different titles to associated existing boilerplate clause data pages and with new or revised content. If the assembly processor 152 identifies that a more current version of the data page is available at the step 808, the assembly processor 152 executes the step 810 as described above, replacing the data page in the ordered list with the more current version. If the assembly processor 152 does not identify a more current version of the data page at the step 808, the assembly processor 152 does not replace the data page in the ordered list (the step 812). In certain implementations, the versioning method illustrated in FIG. 8 is performed by the assembly processor 152 prior to processing the data in the form page in accordance with the flow diagram 100 of FIG. 1A. In certain implementations, the versioning method illustrated in FIG. 8 includes one or more notifications or requests for permission from one or more users or administrators of the system 150. For example, the assembly processor 152, upon creating or detecting a new version of a data page, may take one or more actions including notifying the user, requesting permission of the user before replacing the data page in the ordered list with the more current version, and notifying one or more past users of the data page.

Several techniques are described herein in which the assembly processor 152 searches a collection of data pages or other data files to identify pages matching certain criteria. When searching a collection of data, the assembly processor 152 may execute the search by examining different collections according to a search priority. FIG. 9 is a Venn diagram 900 of relationships between different collections of data files, the data files stored in the memory 158 of the document assembly system 150, or accessible to the document assembly system 150 via the connection to the network 160. The collection 902 represents pages included in a particular binder. The collection 904 represents pages that have been previously used by the user in a binder (and may include pages that have been “favorited,” authored, or otherwise collected or identified by a user as being relevant or valuable). The collection 906 represents pages that have been used in documents similar to the document defined by the particular binder (e.g., as determined by the assembly processor 152 using an analysis of data pages that are commonly used together in different binders, pattern matching or natural language processing algorithms on the content or metadata of the binders, or as determined by the votes or ratings of users of the document assembly system 150). The collection 908 includes pages used by other users within the particular user's organization (e.g., colleagues, business associates). The collection 910 includes pages used in the profession or specialty of the user (e.g., licensing agreements, property agreements, purchase orders, warranties). The collection 912 includes all data pages available to users of the document assembly system 150 and the collection 914 includes all data files available to users (which may include sources such as websites, reviews, encyclopedia entries, any Internet or bulletin board content, etc.). A user (or administrators in a user's organization) may program the search priority among these collections (and/or other collections) into the assembly processor 152, which the assembly processor 152 then follows during document assembly, if collections of non-binder materials are to be searched.

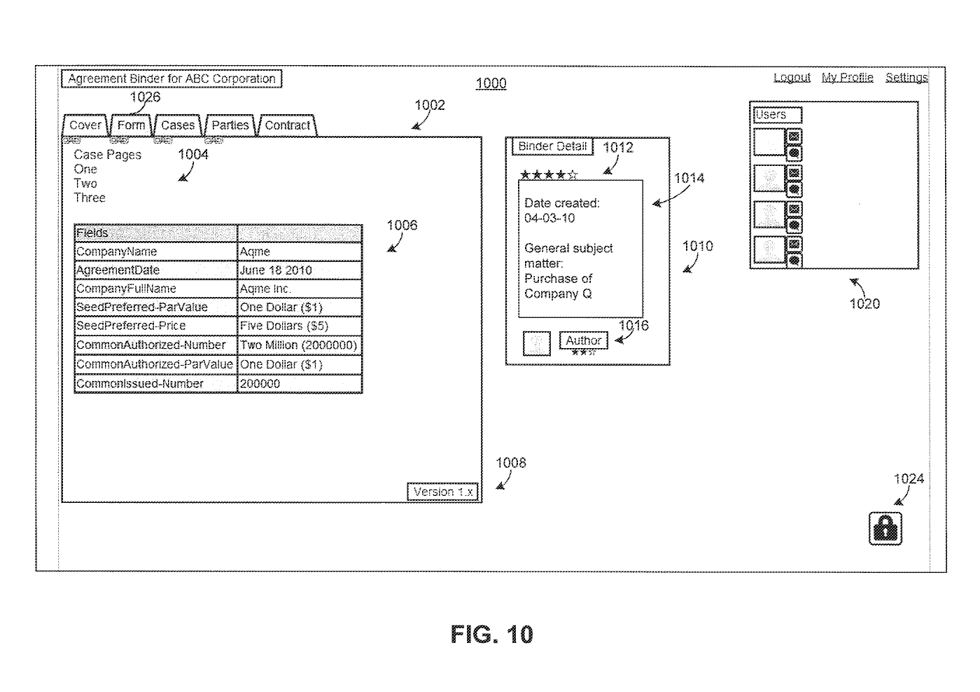

FIG. 10 depicts another user interface display 1000 that can be used with the document assembly techniques disclosed herein. The display 1000 includes a data page region 1002 which includes a list of case pages 1004 as well as a set of fields 1006. The display 1000 also includes a binder detail region 1010 which provides information regarding the binder, including a rating 1012 (e.g., as provided by different users of the document assembly system 150), a description region 1014 including the binder's date of creation and general subject matter, and an author region 1016 for identifying and describing the author of the binder. The display 1000 further includes a users region 1020 which provides descriptions of other users of the document assembly system 150 (and may be limited to other users authorized to view or edit the document associated with the binder). In certain implementations, user comments regarding the data pages or form page included in the binder are presented in at least one of the binder detail region 1010 and the users region 1020. These user comments may aid the user in selecting and editing data and form pages for inclusion in the binder.

The display 1000 also includes a lock button 1024. In certain implementations, when a user selects the lock button 1024, the assembly processor 152 ensures that when a document is generated from the binder, the form and data pages used during assembly are the form and data pages current when the lock button 1024 was selected (i.e., no subsequent revisions or updates are included). Locking may also apply to any other data pages used during document assembly, including those not listed as being part of the binder (e.g., those taken from a database of data pages during document assembly). The versioning may be done by a data page naming system such as Sec_Law_v001, Sec_Law_v002, etc. The “lock” function may be performed by creating a new high priority data page that includes the field “Sec_Law=Sec_Law_v003” (or adding such a field to an existing high priority data page). In this embodiment, when the field indicator “{Sec_Law}” appears, the data page “Sec_Law_v003” is used to provide associated items (instead of a newer or different version of the “Sec_Law” data page).

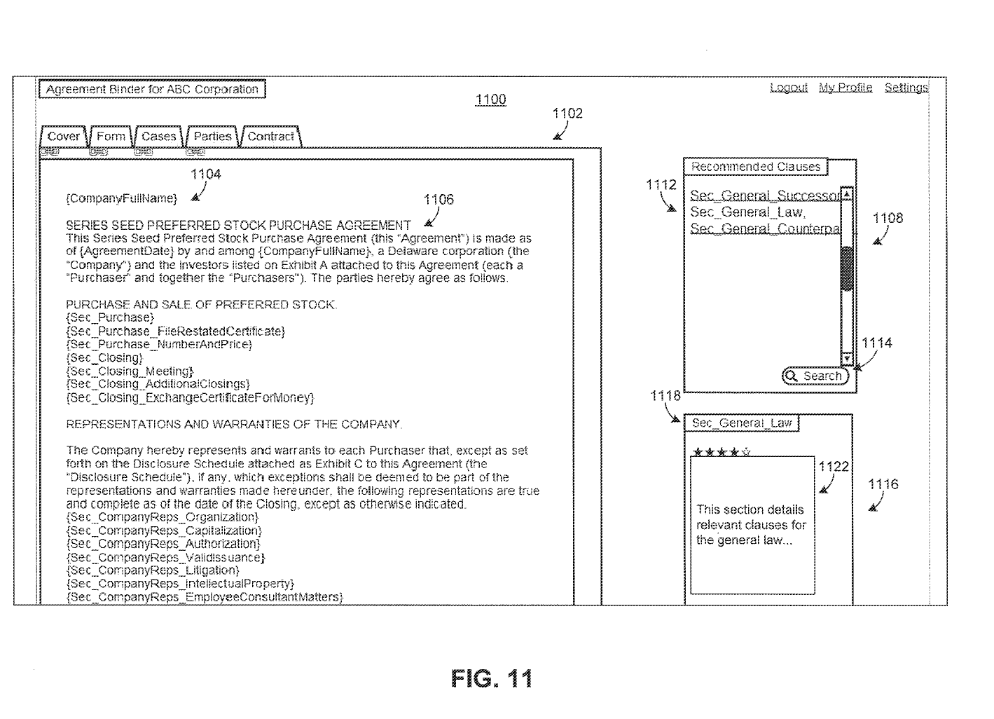

When a user selects the tab 1026 of the display 1000, the display 1100 of FIG. 11 is presented. The display 1100 includes a form data region 1102 in which the form data is presented. The form data presented in the form data region 1102 includes both field indicators such as the field indicator 1104 and text content such as the text content 1106. The display 1100 also includes a recommended clauses region 1108 which provides a list of recommended clauses to the user. When a user selects a recommended clause such as the recommended clause 1112 from the recommended clauses region 1108, a description of the selected clause is presented in the clause description region 1116. In FIG. 11, the clause description region 1116 includes the clause title 1118, a rating of the clause 1120 and a clause description 1122. The recommended clauses region 1108 also includes a search button 1114 which a user may select to search the available clauses.

The assembly processor 152 may present clause recommendations to a user based on an analysis of data pages that are commonly used together in different binders, pattern matching or natural language processing algorithms on the content or metadata of the binder, as determined by the votes or ratings of users of the document assembly system 150. In these implementations, a recommendation for a user input is presented to a user based at least in part on some of the content of the binder (i.e., the ordered list of data pages and the form page). In certain implementations, the assembly processor 152 analyzes the data in one of the data pages or the data in the form page and detects a similarity to an existing data or form page. The assembly processor 152 then recommends that the user consider this existing data or form page. The assembly processor 152 may also indicate other users who have created similar documents.

The recommended clauses region 1108 may include or be replaced with a document advisor region, which provides a user with information to guide the user through the creation of a document. In certain implementations, the document advisor takes the form of a series of queries regarding document content and the user's preferences for data and form pages. This series of queries can be thought of as a document assembly “decision tree,” in which the user's responses determine which data and form pages are included in the document, as well as the next query to be presented. The queries may be based on binders previously created by the user and/or decisions made by other users of the system 150. For example, when a user indicates that a contract should include an intellectual property provision, the assembly processor 152 may present one or more of the most popular intellectual property provision data pages in its memory 150 (as determined by use or rating), and allow the user to select which provisions to include.

A user or a user's organization may customize the document assembly system 150 with approved or recommended data pages and form pages to ensure that generated documents comply with organization policies. In certain embodiments, a user or a user's organization may provide an indication of document assembly requirements to the assembly processor 152, prior to processing the data in the form page. These document assembly requirements may include one or more data or form pages that must be included in the ordered list in a binder, guidelines for the user on data that is allowed to be included in at least one of the plurality of data pages, or any combination thereof.

For example, a company's legal department can create a data page including the following data fields:

Sec_Law={AqmeLegalDept_Sec_Law}

Sec_Forum={CmAccGen_Forum_v39}

By including this data page in a binder with a high priority, any document generated using this binder will first look to this data page for content to replace field indicators in the form page, and thus will preferentially include the content approved by the legal department. In such embodiments, a user may include a data page with their preferred content with even higher priority than the legal department data page. In certain implementations, the document assembly system 150 can be configured by to limit the data pages that can be included in a binder, and/or the order in which data pages are included (e.g., by setting binder requirements within the programming of the assembly processor 152).

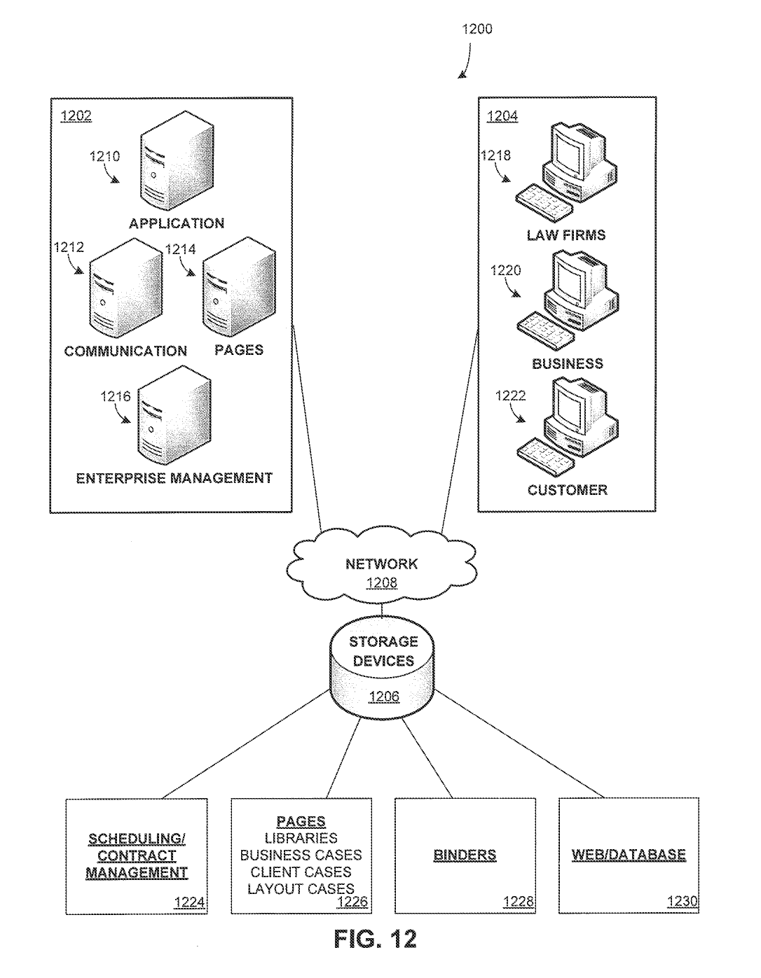

In certain embodiments, the document assembly system 150 may be implemented over a network of devices, with different tasks distributed over one or more devices in the network. FIG. 12 depicts a network-based system 1200 configured to serve as the document assembly system 150 and perform the document assembly techniques described herein. The system 1200 includes the server devices 1202, the client devices 1204, a network 1208 and the storage devices 1206. The server devices 1202 include an application server 1210, a communication server 1212, a pages server 1214 and an enterprise management server 1216. The operations of the assembly processor 152 may be distributed over one of more these server devices, and the server devices may also provide the functions customarily provided by such server devices (e.g., the enterprise management server 1216 may provide enterprise management applications and services along with the document assembly techniques described herein). The client devices 1204 include law firm client devices 1218, business client devices 1220 and customer client devices 1222. These client devices may include presentation devices (such as the presentation device 154) and input devices (such as the input device 156). The storage devices 1206 include data stores such as related scheduling/contract management store 1224, data pages store 1226, binder store 1228 and web/database store 1230. The document assembly system 150 may reside at any location (e.g., client or server) accessible to the network, as may the data pages and binder information. In certain implementations, different intranet-based servers provided by different organizations (e.g., different companies and law firms) and operating behind different firewalls, draw data from and contribute data to a public server. In such implementations, the public server may act as one or more of a central repository, processing entity and contact point for a network-based implementation of the system 150.

In certain embodiments, the document assembly techniques described herein provide distributed editing capability to multiple users at different client devices connected to a network. In such an embodiment of the document assembly system 150, a plurality of users have access to and editing rights over binders, data pages and form pages. Versioning (as described above) may be used to avoid conflicts between different users. Additionally, different data pages and portions of the form page may be assigned to different users based on their expertise or access rights. For example, the IP sections of an agreement binder may be assigned and accessible to an IP lawyer, while a data page including the description of a physical installation may be assigned and accessible to the engineer. In some such implementations, different users are given access to different pages in a “deal locker,” and may work independently. These pages are then included in a binder and become part of the generated document.

It is to be understood that while various illustrative embodiments have been described, the forgoing description is merely illustrative and does not limit the scope of the invention. While several examples have been provided in the present disclosure, it should be understood that the disclosed systems, components, and methods may be embodied in many other specific forms without departing from the scope of the present disclosure.

The examples disclosed can be implemented in sub-combinations with one or more other features described herein. For example, a variety of systems and methods may be implemented based on the disclosure and still fall within the scope of the invention. Also, the various features described or illustrated above may be combined or integrated in other systems or certain features may be omitted, or not implemented.

Examples of changes, substitutions, and alterations are ascertainable by one skilled in the art and could be made without departing from the scope of the information disclosed herein. Certain particular aspects, advantages, and modifications are within the scope of the following claims. All references cited herein are incorporated by reference in their entirety and made part of this application.

What is claimed is:

1. A method of assembling a document, comprising:
presenting a plurality of data pages to a user with a presentation device, each data page having at least one field, wherein:
a field includes a field name and an associated item, and
the associated item includes at least one of content and an indicator of another field;
receiving an input from the user, via an input device, the input comprising an indication of:
a form page, selected by the user, having data including at least one field indicator;
a list of at least some of the plurality of data pages arranged by the user in an order indicative of the user's assembly priority of such data pages;
processing the form page data, wherein:
(a) processing content includes outputting the content to the document, and
(b) processing a field indicator includes:
identifying the highest priority data page in the ordered list that includes a field matching the field indicator,
identifying the item associated with the field,
when the associated item is content, processing the content according to step (a); and
when the associated item includes a field indicator, processing the field indicator according to step (b).

2. The method of claim 1, wherein the associated item includes a field indicator by including a portion of a field indicator, and processing the field indicator according to step (b) comprises processing the field indicator, of which the associated item includes a portion, according to step (b).

3. The method of claim 1, further comprising, when the associated item includes a field indicator, modifying the form page data by inserting the associated item into the form page data.

4. The method of claim 1, further comprising outputting all of the form page data to the document, wherein processing the form page data comprises processing the form page data in the document.

5. The method of claim 1, further comprising, when no form indicators remain to be processed in the form page data, signaling completion of document assembly with the presentation device.

6. The method of claim 1, wherein at least one of the data pages in the ordered list is a case page that customizes the document for a user-selected application.

7. The method of claim 1, wherein at least one of the data pages in the ordered list is a cover page that provides content for the document that is particular to a specific document.

8. The method of claim 1, wherein a field indicator is a string of text demarcated by predetermined escape characters.

9. The method of claim 8, wherein at least one field indicator comprises multiple text strings separated by predetermined delimiter characters, each text string matching at least one of: a field name included in at least one of the plurality of data pages, and a name of a data page of the plurality of data pages.

10. The method of claim 1, wherein the input further comprises an indication of at least one edit to at least one data page in the ordered list, and the method further comprises:
updating the at least one data page with the at least one edit prior to processing the form page data.

11. The method of claim 10, further comprising presenting the at least one data page to the user as a text file in a text editor, wherein the indication of at least one edit includes a change made by the user to the text file in the text editor.

12. The method of claim 11, wherein the text file is an HTML file.

13. The method of claim 10, wherein updating the at least one data page comprises creating a new version of the at least one data page and replacing the at least one data page in the ordered list of data pages with the new version.

14. The method of claim 10, wherein the indication of at least one edit is associated with metadata indicating at least one of an identity of the user, a time of the at least one edit, the ordered list in connection with which the at least one edit was made, and a reason for the at least one edit.

15. The method of claim 1, further comprising determining that a data page in the ordered list is associated with a more current version, and replacing the data page in the ordered list with the more current version prior to processing the form page data.

16. The method of claim 1, further comprising determining that a data page in the ordered list is associated with a more current version, and further comprising at least one of: notifying the user, requesting permission of the user before replacing the data page in the ordered list with the more current version, and notifying one or more past users of the data page.

17. The method of claim 1, further comprising receiving an indication of document assembly requirements prior to processing the form page data, the document assembly requirements including at least one of:
one or more data pages that must be included in the ordered list, and
guidelines for the user on data that is allowed to be included in at least one of the plurality of data pages.

18. The method of claim 1, further comprising, when no data page in the ordered list includes a field that matches the field indicator, determining whether a data page of the plurality of data pages has a page name matching the field indicator.

19. The method of claim 18, wherein, when a data page of the plurality of data pages has a page name matching the field indicator, the field name comprises the page name and the item associated with the field name comprises the data in the data page.

20. The method of claim 1, further comprising, when no data page in the ordered list includes a field matching the field indicator, outputting a marker to the document.

21. The method of claim 1, further comprising, when no data page in the ordered list includes a field that matches the field indicator, including a new data page in the ordered list, wherein the new data page includes a field that matches the field indicator.

22. The method of claim 1, further comprising, when no data page in the ordered list includes a field name that matches the field indicator, including a new field in a data page in the ordered list, wherein the new field matches the field indicator.

23. The method of claim 1, further comprising presenting an input recommendation to a user based at least in part on at least one of the ordered list of data pages and the form page.

24. The method of claim 1, wherein the plurality of data pages are presented to the user as a wiki application executed by a server.

25. The method of claim 24, wherein the processing of the data in the form page is performed by the server.

26. The method of claim 1, further comprising presenting to the user the document and information regarding at least some of the data pages in the ordered list.

27. A processing device, configured to communicate with a user input device and a presentation device, and further configured to:
present a plurality of data pages to a user via the presentation device, each data page having at least one field, wherein:
a field includes a field name and an associated item, and
the associated item includes at least one of content and an indicator of another field;
receive an input from the user, via the input device, the input comprising an indication of:
a form page, selected by the user, having data including at least one field indicator;
a list of at least some of the plurality of data pages arranged by the user in an order indicative of the user's assembly priority of such data pages;
process the form page data, wherein:
(a) processing content includes outputting the content to the document, and
(b) processing a field indicator includes:
identifying the highest priority data page in the ordered list that includes a field matching the field indicator,
identifying the item associated with the field,
when the associated item is content, processing the content according to step (a); and
when the associated item includes a field indicator, processing the field indicator according to step (b).

28. The processing device of claim 27, wherein the associated item includes a field indicator by including a portion of a field indicator, and processing the field indicator according to step (b) comprises processing the field indicator, of which the associated item includes a portion, according to step (b).

29. The processing device of claim 27, further configured to, when the associated item includes a field indicator, modify the form page data by inserting the associated item into the form page data.

30. The processing device of claim 27, further configured to output all of the form page data to the document, wherein processing the form page data comprises processing the form page data in the document.

31. The processing device of claim 27, further configured to, when no form indicators remain to be processed in the form page data, signaling completion of document assembly with the presentation device.

32. The processing device of claim 27, wherein a field indicator is a string of text demarcated by predetermined escape characters.

33. The processing device of claim 27, further configured to, when no data page in the ordered list includes a field that matches the field indicator, determine whether a data page of the plurality of data pages has a page name matching the field indicator.

34. The processing device of claim 33, wherein, when a data page of the plurality of data pages has a page name matching the field indicator, the field name comprises the page name and the item associated with the field name comprises the data in the data page.

35. The processing device of claim 27, further configured to present an input recommendation to a user based at least in part on at least one of the ordered list of data pages and the form page.

36. The processing device of claim 27, wherein the processing device is included in a web server.

37. The processing device of claim 27, wherein the processing device is included in a local server.

38. The processing device of claim 27, wherein the user input device is a handheld user device.

39. The processing device of claim 27, wherein the user input device uses a wireless communication protocol to communicate with the processing device.
